(19) United States
(12) Patent Application Publication
(10) Pub. No.: US 2024/0079812 A1
(43) Pub. Date: Mar. 7, 2024

(54) Electrical Connector

(71) Applicants: Tyco Electronics (Shanghai) Co., Ltd., Shanghai (CN); Tyco Electronics AMP Korea Co., Ltd., Gyeongsan (KR)

(72) Inventors: Wenfang (Felix) Zhang, Shanghai (CN); Yongjian (Justin) Huang, Shanghai (CN); Tongbao (Tim) Ding, Shanghai (CN); Suk-Eun Jung, Gyeongsan-Si (KR)

(73) Assignees: Tyco Electronics (Shanghai) Co., Ltd., Shanghai (CN); Tyco Electronics AMP Korea Co., Ltd., Gyeongsan (KR)

(21) Appl. No.: 18/241,378

(22) Filed: Sep. 1, 2023

(30) Foreign Application Priority Data
Sep. 1, 2022 (CN) 202211067830.7

(51) Int. Cl. H01R 13/436; H01R 13/506

(52) U.S. Cl. CPC H01R 13/4361; H01R 13/506

(57) ABSTRACT

An electrical connector comprises a housing and a terminal position assurance. The housing includes a cavity extending along a cavity axis, with one side of the cavity having a positioning hole, and a pair of sides. The terminal position assurance has a top wall having a positioning column extending downward therefrom and aligned with the positioning hole, and two side walls extending downward from the top wall. The side walls selectively engage with the pair of sides of the housing in a first locking position and a second locking position. The first and second locking positions are defined along an actuation axis perpendicular to the cavity axis. In the first locking position, the positioning column is held out of the cavity. In the second locking position, the positioning column is moved into the cavity and is adapted to engage with a terminal arranged within the cavity.

### CROSS-REFERENCE TO RELATED APPLICATION

This application claims the benefit of Chinese Patent Application No. 202211067830.7 filed on Sep. 1, 2022, in the State Intellectual Property Office of China, the whole disclosure of which is incorporated herein by reference.

### FIELD OF THE INVENTION

The disclosure relates to the field of electronic connection fittings, and in particular, to an electrical connector having a terminal position assurance.

### BACKGROUND

As shown in FIG. 1, an existing electrical connector 10 having a terminal position assurance (TPA) includes a housing 12, a terminal 16 and a terminal position assurance 14. During assembly of the connector 10, the terminal 15 is inserted into the housing 12. Next, the terminal position assurance 14 is installed along an insertion direction of the terminal 16 to ensure that the terminal reaches a preset position. In the electrical connector 10, the terminal position assurance 14 needs to be installed along the insertion direction of the terminal 16 and the terminal position assurance cannot be pre-assembled, which is not conducive to improving the assembly efficiency, and is difficult to achieve via automated assembly.

### SUMMARY

According to an embodiment of the present disclosure, an electrical connector comprises a housing and a terminal position assurance. The housing includes a cavity extending along a cavity axis, with one side of the cavity having a positioning hole, and a pair of sides. The terminal position assurance has a top wall defining a positioning column extending downward therefrom and aligned with the positioning hole, and two side walls extending downward from the top wall. The side walls selectively engage with the pair of sides of the housing in each of a first locking position and a second locking position. The first and second locking positions are defined along an actuation axis perpendicular to the cavity axis. In the first locking position, the positioning column is held out of the cavity. In the second locking position, the positioning column is moved into the cavity and is adapted to engage with a stopper of a terminal arranged within the cavity such that the terminal reaches and remains in a preset position.

### BRIEF DESCRIPTION OF THE DRAWINGS

The invention will now be described by way of example with reference to the accompanying Figures, of which:

FIG. 1 is an assembly view of an existing electrical connector 10.

FIG. 2 is an assembly view of an electrical connector 20 according to an embodiment of the present disclosure.

FIG. 3a is a schematic view of a pre-assembly structure of the electrical connector 20 shown in FIG. 2 in the assembly process.

FIG. 3b is a cross-sectional view of the pre-assembly structure of the electrical connector 20 shown in FIG. 3a.

FIG. 3c is a partially enlarged view of the pre-assembly structure of the electrical connector 20 shown in FIG. 3b.

FIG. 4a is a schematic structural view showing that a terminal is inserted into the electrical connector 20 shown in FIG. 2.

FIG. 4b is a corresponding cross-sectional view of the electrical connector 20 shown in FIG. 4a.

FIG. 4c is a schematic structural view of the terminal according to an embodiment of the present disclosure.

FIG. 4d is a cross-sectional view of the terminal shown in FIG. 4c.

FIG. 4e is a partially enlarged view of the electrical connector 20 shown in FIG. 4b.

FIG. 5a is a schematic structural view of the electrical connector 20 shown in FIG. 2 after the assembly is finished.

FIG. 5b is a corresponding cross-sectional view of the electrical connector 20 shown in FIG. 5a.

FIG. 5c is a partially enlarged view of the electrical connector 20 shown in FIG. 5b.

FIG. 5d is a corresponding longitudinal sectional view of the electrical connector 20 shown in FIG. 5a.

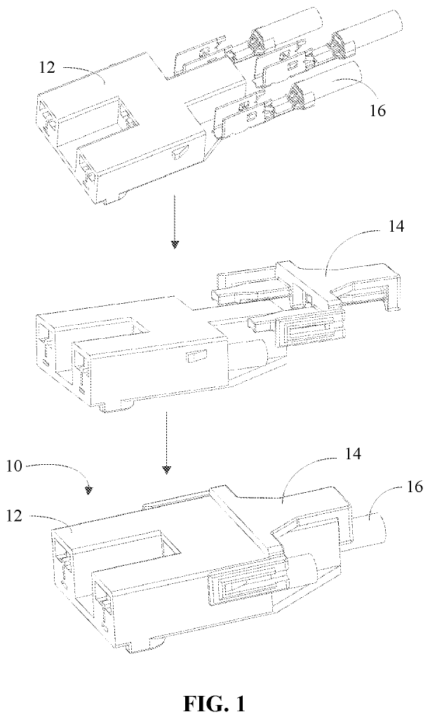

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

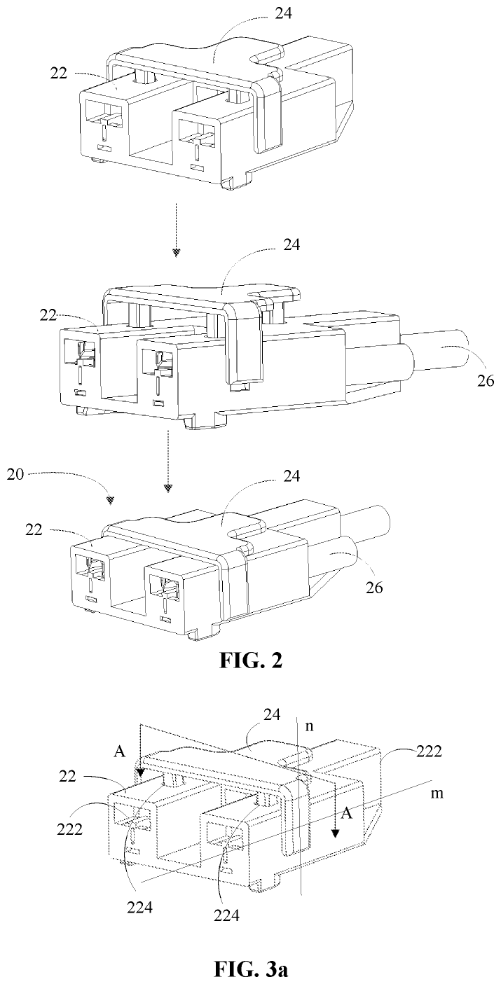

FIG. 2 is an assembly view of an electrical connector 20 according to an embodiment of the present disclosure. The electrical connector 20 according to an embodiment of the present disclosure may be adapted to any suitable electrical connection loop for transmitting electrical signals or conducting electricity. For example, it may be applied to compressors and so on. The electrical connector 20 includes a housing 22, a terminal position assurance or terminal position assurance member 24, and a terminal 26. The assembly method of the electrical connector is as follows: first, the terminal position assurance 24 is sleeved on the housing 22 in a direction perpendicular to an insertion direction of the terminal 26 to achieve pre-assembly of the electrical connector; then, the terminal 26 is inserted into the housing 22; and finally, the terminal position assurance 24 is pressed down to ensure that the inserted terminal 26 reaches and remains in a preset position. The present embodiment can achieve the pre-assembly of the terminal position assurance, and facilitate the assembly of the electrical connector, so as to improve the assembly efficiency of the electrical connector and achieve the automated assembly of the electrical connector. Therefore, the manufacturing cost of the electrical connector can be reduced and the competitive power of products can be improved.

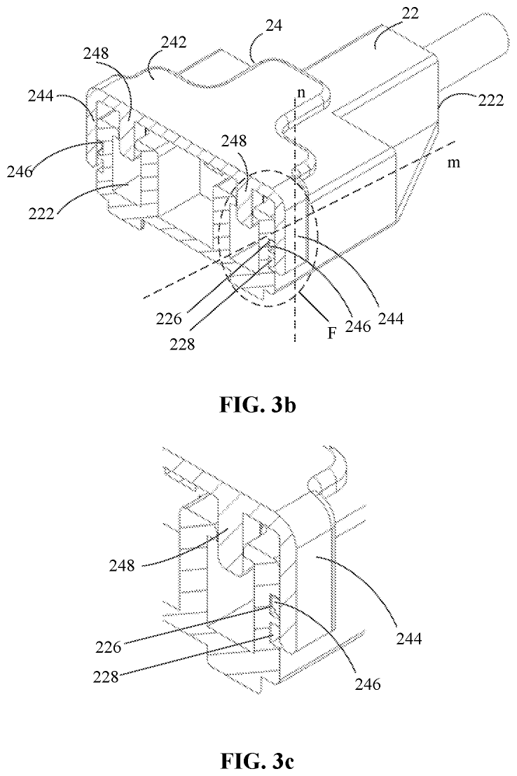

FIGS. 3a-3c are schematic views of the pre-assembly structure of the electrical connector 20 shown in FIG. 2, wherein FIG. 3a is a perspective view of the pre-assembly structure, FIG. 3b is a sectional view taken along line A-A in FIG. 3a, and FIG. 3c is an enlarged view of the region F in FIG. 3b. As shown in FIGS. 3a-3c, the housing 22 is provided with a cavity 222 extending along a cavity axis m for receiving the terminal 26 of a corresponding structure, a positioning hole 224 is arranged at one side of the cavity, and a first locking position, element or feature 226 and a second locking position, element or feature 228 are provided on two sides of the housing along an actuation axis n perpendicular to the cavity axis m. The terminal position assurance 24 includes a top wall 242. Two ends of the top wall 242 extend downward to form side walls 244, and connection parts 246 are provided on an inner side of the side walls. The terminal position assurance 24 is sleeved on the housing 22 and connected with the first locking position 226 via the connection parts 246 to be fixed to the housing. A positioning column 248 (the position and number of the positioning column match the position and number of the positioning hole, and the number of the positioning hole is not less than the number of the cavity and the number of the terminal) extends downward from the top wall 242. The positioning column 248 is inserted into the positioning hole 224 and held out of a loading path of the terminal 26 due to the limitation from the first locking position 226. In the present embodiment, the terminal position assurance 24 is assembled in a direction perpendicular to the insertion direction of the terminal 26 by means of the new design structure, and, a design of dual-position locking function (first locking position and second locking position) achieves the pre-assembly of the terminal position assurance out of the loading path and achieves the automated assembly.

In some examples, each of the first locking position 226 and the second locking position 228 correspond to mounting grooves symmetrically arranged on two sides of the housing 22. That is, the first locking position 226 comprises a group of mounting grooves symmetrically arranged on two sides of the housing 22, and the second locking position 228 comprises another group of mounting grooves symmetrically arranged on two sides of the housing 22. The connection parts 246 are protrusions corresponding to the mounting grooves so as to be connected with the mounting grooves by snapping. Specifically, the first locking position 226 is close to a mounting side of the terminal position assurance, and the distance between the second locking position 228 and the first locking position corresponds to the displacement of the positioning column 248 while the positioning column acts on the terminal. In some examples, each protrusion 246 includes an inclined structure, and when the connection parts are moved from the first locking position 226 to the second locking position 228. The inclined surface of the inclined structure slides along the edge of the first locking position to enter the second locking position. The protrusion 246 may be a triangular prism, a quadrangular, a triangular pyramid, or a hook, including an inclined structure.

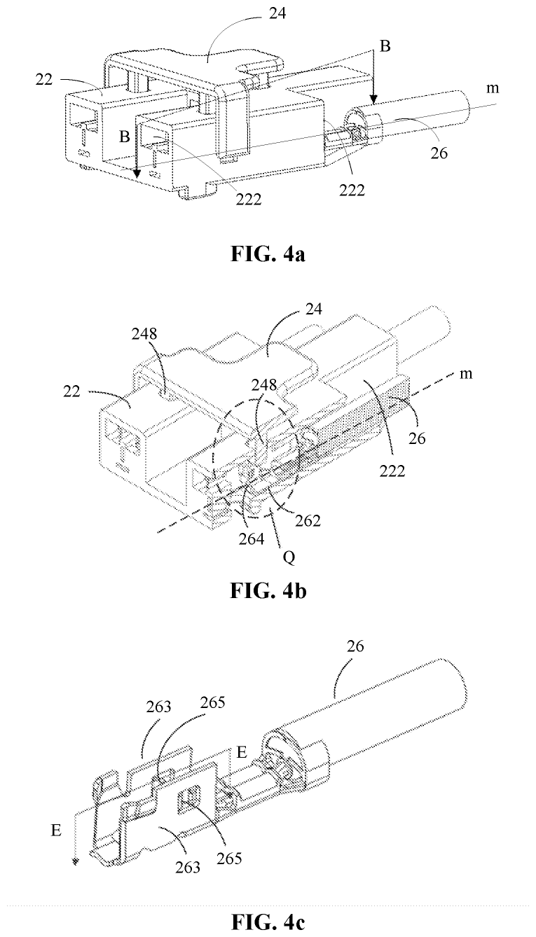

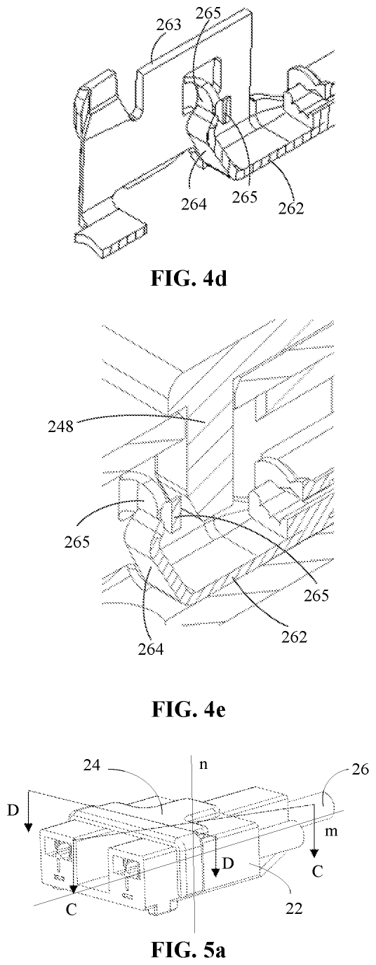

FIG. 4a and FIG. 4b are schematic structural views showing that the terminal is inserted into the electrical connector 20 shown in FIG. 2, wherein FIG. 4b is a sectional view taken along line B-B shown in FIG. 4a. FIG. 4d and FIG. 4d are schematic structural views of the terminal 26, wherein FIG. 4d is a sectional view taken along line E-E shown in FIG. 4c. FIG. 4e is a partially enlarged view of the region Q in the electrical connector 20 shown in FIG. 4b.

As shown in FIGS. 4a and 4b, the terminal 26 is inserted into the cavity 222 along the cavity axis m. As shown in FIGS. 4c and 4d, the structure of the terminal 26 corresponds to the internal structure of the housing 22. In FIGS. 4a and 4b, three cavities are provided by way of example (but the number of cavities in the present disclosure is not limited). Correspondingly, three terminals 26 are respectively inserted into the cavities, and the terminal position assurance 24 includes at least three positioning columns 248 which are respectively vertically inserted into the positioning holes of the cavities. This ensures that the terminals are loaded in a predetermined position after the terminals are inserted.

Each terminal 26 includes a bottom wall 262 which obliquely extends upward to form an elastic contact arm 264. Each terminal 26 further includes a terminal side wall 263 which is bent inwardly to form a stopper 265 for limiting the displacement of the elastic contact arm 264. Specifically, after the positioning column 248 enters the cavity 222 and before the terminal reaches the preset position, the positioning column abuts against the stopper 265 during the downward insertion process and exerts a thrust force on the stopper, to push the terminal to move to the preset position. When the terminal is to be disengaged due to an external force, the positioning column 248 is located in the disengagement path of the stopper 265 and exerts a resistance on the stopper, thereby holding the terminal in the preset position and preventing the terminal from being disengaged due to an unexpected external force.

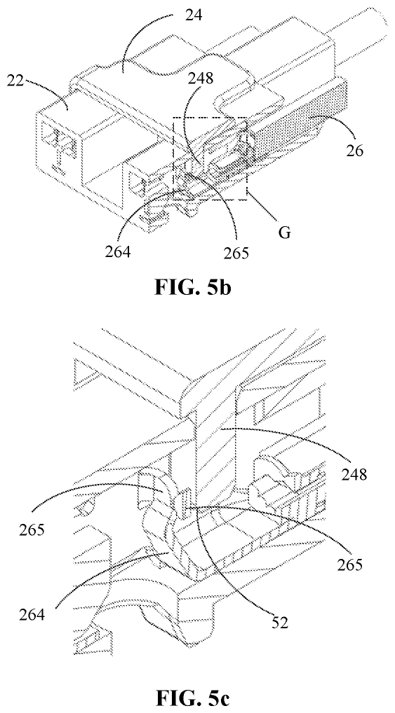

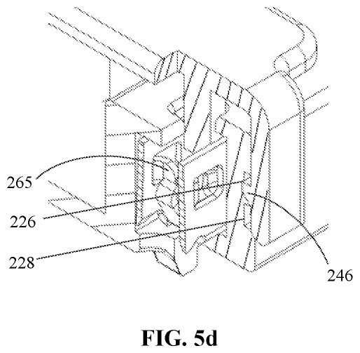

FIGS. 5a-5d are schematic structural views of the electrical connector 20, shown in FIG. 2, after the assembly is finished, wherein FIG. 5a is a perspective view of the electrical connector 20 after the assembly is finished. FIG. 5b is a cross-sectional view of the electrical connector 20 taken along line C-C in FIG. 5a. FIG. 5c is a partially enlarged view of the region G of the electrical connector 20 shown in FIG. 5b. And FIG. 5d is a longitudinal sectional view of the electrical connector 20 taken along line D-D in FIG. 5a.

As shown in FIGS. 5a-5d, after the terminal 26 is loaded into the cavity 222, the terminal position assurance 24 is operated to move along the actuation axis n so that the connection parts 246 move from the first locking position 226 to the second locking position 228. The positioning column 248 enters the cavity 222 and acts on the stopper 265 so that the terminal reaches and remains in the preset position. In some examples, before the terminal 26 reaches the preset position and while the connection parts 246 move from the first locking position 226 to the second locking position 228, the positioning column 248 acts on the stopper 265 and abuts against the stopper to exert a forward thrust on the stopper to advance the terminal to the preset position. When the terminal 26 is to be disengaged due to an external force, the positioning column 248 is located in the disengagement path of the stopper 265 and exerts a resistance on the stopper, thereby holding the terminal in the preset position and preventing the terminal from being disengaged due to an unexpected external force. In some examples, the bottom of the positioning column 248 has a tilted surface 52. Before the terminal 26 reaches the preset position, the positioning column 248 smoothly advances the terminal to the preset position along the tilted surface 52 after entering the cavity 222.

In some examples, the length of a cross section of the inner contour of the terminal position assurance is less than the length of a cross section of the outer contour of the housing, and the terminal position assurance and the housing are of elastic material. Therefore, the terminal position assurance has a clamping force on the housing when sleeved on the housing, and it can move relative to the housing when subjected to an external force. The connection parts of the terminal position assurance can move from the first locking position to the second locking position. The positioning column can abut against the terminal and advance the terminal to the preset position before the terminal reaches the preset position, thereby ensuring the position of the terminal of the electrical connector after the assembly is finished. In some examples, the applicable elastic material of the terminal position assurance or the housing includes: polybutylene terephthalate (PBT), polyamide, polycarbonate, polyformaldehyde, modified polyphenyl ether, polyimide, polyphenylene sulfide, polysulfone, aromatic polyamide, polyarylester, polyphenyl ester, polyarylether ketone, liquid crystal polymer, fluorine resin, etc.

Another electrical connector is further provided according to another embodiment of the present disclosure, which is similar to the electrical connector of the previous embodiment. The only difference lies in a structural exchange at the connection between the housing and the terminal position assurance.

Specifically, the electrical connector in the present embodiment includes a housing having a cavity extending along a cavity axis. A positioning hole is arranged at one side of the cavity, and connecting parts are provided at two sides of the housing. The connector further includes a terminal arranged in the cavity. The terminal includes an elastic contact arm and a stopper configured for limiting a displacement of the elastic contact arm. A terminal position assurance of the connector includes a top wall, wherein two ends of the top wall extend downward to form side walls. A first locking position or feature and a second locking position or feature are provided on an inner side of the side walls along an actuation axis perpendicular to the cavity axis. The terminal position assurance is sleeved on the housing and connected with the connection parts via the first locking position to be fixed to the housing. A positioning column extends downward from the top wall. The positioning column is inserted into the positioning hole and held out of a loading path of the terminal due to the limitation from the first locking position. After the terminal is loaded into the cavity, the terminal position assurance is operated to move along the actuation axis so that the connection parts of the housing move from the first locking position to the second locking position, and the positioning column enters the cavity and acts on the stopper so that the terminal reaches and remains in a preset position.

In some examples, each of the first locking position and the second locking position is mounting grooves symmetrically arranged on the inner side of the side walls of the terminal position assurance, and the connection parts of the housing are protrusions corresponding to the mounting grooves so as to be connected with the mounting grooves by snapping.

In some examples, each protrusion includes an inclined structure, and when the connection parts are moved from the first locking position to the second locking position, the inclined surface of the inclined structure slides along the edge of the first locking position to enter the second locking position.

In some examples, the bottom of the positioning column has a tilted surface so that the positioning column smoothly advances the terminal to the preset position along the tilted surface after entering the cavity.

In some examples, the terminal includes a terminal side wall bent inwardly to form the stopper, where the positioning column abuts against the stopper after entering the cavity, so as to ensure that the terminal reaches the preset position and remains in the preset position.

In some examples, the length of a cross section of the inner contour of the terminal position assurance is less than the length of a cross section of the outer contour of the housing, and the terminal position assurance and the housing are of elastic material.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector, comprising:
a housing, including:
a cavity extending along a cavity axis, one side of the cavity having a positioning hole; and
a pair of sides, each side defining a first locking feature and a second locking feature defined along an actuation axis perpendicular to the cavity axis;
a terminal arranged in the cavity and including an elastic contact arm and a stopper limiting a displacement of the elastic contact arm; and
a terminal position assurance sleeved on the housing and having a top wall and two ends extending downward therefrom to form side walls, an inner side of each side wall having a connection part, the terminal position assurance connectable with one of the first locking features or the second locking features via the connection parts to fix the terminal position assurance to the housing.

2. The electrical connector according to claim 1, wherein the top wall includes a positioning column extending downward, the first locking features constrain the positioning column inserted into the positioning hole and holds the positioning column out of a loading path of the terminal.

3. The electrical connector according to claim 2, wherein after the terminal is loaded into the cavity, the terminal position assurance is operable to move along the actuation axis such that the connection parts move from the first locking features to the second locking features.

4. The electrical connector according to claim 2, wherein as the terminal position assurance is moved from the first locking features to the second locking features, the positioning column acts on the stopper of the terminal such that the terminal reaches and remains in a preset position.

5. The electrical connector according to claim 4, wherein each of the first locking features and the second locking features include mounting grooves symmetrically arranged on the two sides of the housing, and the connection parts are protrusions corresponding to the mounting grooves.

6. The electrical connector according to claim 5, wherein the protrusions each include an inclined structure, as the connection parts are moved from the first locking features to the second locking features, an inclined surface of the inclined structure slides along an edge of the first locking feature to enter the second locking feature.

7. The electrical connector according to claim 4, wherein a bottom of the positioning column has an angled surface enabling the positioning column to smoothly advance the terminal to the preset position along the angled surface after entering the cavity.

8. The electrical connector according to claim 4, wherein the terminal includes a terminal side wall bent inwardly to form the stopper, the positioning column abuts against the stopper after entering the cavity so that the terminal reaches the preset position and remains in the preset position.

9. The electrical connector according to claim 4, wherein a length of a cross section of an inner contour of the terminal position assurance is less than a length of a cross section of an outer contour of the housing, and the terminal position assurance and the housing are formed from elastic material.

10. An electrical connector, comprising:
a housing including:
two sides each having a connection part; and
a cavity extending along a cavity axis, one side of the cavity having a positioning hole;
a terminal arranged in the cavity and including an elastic contact arm and a stopper adapted to limit a displacement of the elastic contact arm; and
a terminal position assurance sleeved on the housing and including:
a top wall; and
side walls extending downwardly from ends of the top wall, an inner side of the each of the side walls including a first locking feature and a second locking feature arranged along an actuation axis perpendicular to the cavity axis, the terminal position assurance connectable with the connection parts via the first locking features or the second locking features to fix the terminal position assurance to the housing.

11. The electrical connector according to claim 10, wherein the top wall includes a positioning column extending downward, the first locking features constrain the positioning column inserted into the positioning hole and holds the positioning column out of a loading path of the terminal.

12. The electrical connector according to claim 11, wherein after the terminal is loaded into the cavity, the terminal position assurance is operable to move along the actuation axis such that the connection parts of the housing move from the first locking features to the second locking features, and the positioning column enters the cavity and acts on the stopper such that the terminal reaches and remains in a preset position.

13. The electrical connector according to claim 12, wherein each of the first locking features and the second locking features include mounting grooves symmetrically arranged on the inner side of the side walls of the terminal position assurance, and the connection parts of the housing are protrusions corresponding to the mounting grooves, the connection parts are connected with the mounting groove by a snap fit.

14. The electrical connector according to claim 13, wherein each protrusion includes an inclined structure, and when the connection part is moved from the first locking feature to the second locking feature, an inclined surface of the inclined structure slides along an edge of the first locking position to enter the second locking position.

15. The electrical connector according to claim 12, wherein a bottom of the positioning column has an angled surface which enables the positioning column smoothly advances the terminal to the preset position along the angled surface after entering the cavity.

16. The electrical connector according to claim 12, wherein the terminal includes a terminal side wall bent inwardly to form the stopper, wherein the positioning column abuts against the stopper after entering the cavity, so that the terminal reaches the preset position and remains in the preset position.

17. The electrical connector according to claim 12, wherein a length of a cross section of an inner contour of the terminal position assurance is less than a length of a cross section of an outer contour of the housing, and the terminal position assurance and the housing are of elastic material.

18. An electrical connector, comprising:
a housing, including:
a cavity extending along a cavity axis, one side of the cavity having a positioning hole; and
a pair of sides;
a terminal position assurance arranged over the housing, including:
a top wall defining a positioning column extending downward therefrom and aligned with the positioning hole; and
two side walls extending downward from the top wall, the side walls selectively engageable with the pair of sides of the housing in each of a first locking position and a second locking position, the first and second locking positions defined along an actuation axis perpendicular to the cavity axis, wherein:
in the first locking position, the positioning column is held out of a loading path of the terminal; and
in the second locking position, the positioning column is moved into the cavity and is adapted to engage with a stopper of a terminal arranged within the cavity such that the terminal reaches and remains in a preset position.

19. The electrical connector according to claim 18, wherein:
each side of the housing defines a pair of grooves, one of the grooves of the pair of grooves corresponds to the first locking position and the other one of the grooves of the pair of grooves corresponds to the second locking position; and
each of the side walls of the terminal position assurance defines a protrusion engaging with a respective one of the pair of grooves in the first locking position and the second locking position.

20. The electrical connector according to claim 18, wherein:
each of the side walls of the terminal position assurance defines a pair of grooves, one of the grooves of the pair of grooves corresponds to the first locking position and the other one of the grooves of the pair of grooves corresponds to the second locking position; and
each side of the housing defines a protrusion engaging with a respective one of the pair of grooves in the first locking position and the second locking position.
